(19) United States
(12) Patent Application Publication
(10) Pub. No.: US 2007/0094699 A1
(43) Pub. Date: Apr. 26, 2007

(54) Signal processing device

(76) Inventor: Yi-Hsi Chen, His-Chih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/257,027

(22) Filed: Oct. 25, 2005

(51) Int. Cl. H04N 7/18; H04N 11/00; H04N 7/00; H04N 7/173; H04N 7/16

(52) U.S. Cl. 725/133; 348/552; 725/80; 725/81; 725/141

(57) ABSTRACT

A signal processing device, consisting of a signal processing unit for conversion, amplification and resumption of signals, an input unit in the form of an HDMI connector a DVI connector or a transmission line, the input unit being connected with the signal processing unit, for connection with an audio-video player device, to receive input of signals from the audio-video player device, and an output unit in the form of an HDMI connector, a DVI connector or a transmission line, and an output unit in the form of an HDMI connector a DVI connector, or a transmission line, the output unit being connected with the signal processing unit, for connection with a display device, for transmission of signal output on the display device. Thereby, the signals transmitted from the audio-video player device are received by the signal processing unit, where they are resumed and amplified, to achieve the purpose of steadily transmitting signals from the audio-video player device to the display device.

### BACKGROUND OF THE INVENTION

1. Field of the invention

The present invention relates to a signal processing device, particularly to one that steadily transmits signals from an audio-video player device to a display device.

2. Description of the Related Art

Due to the ever-changing development of electronic technology in recent years, digital products such as audio-video household electrical appliances have become more and more popular. Generally speaking, because all digital products are independent individual units, they have to rely completely on conductive wires to transmit signals in order to connect and use a variety of digital devices, such as audio-video player devices and display devices. Due to various factors such as indoor space and wiring considerations, a longer signal wire is needed to satisfy wiring purposes. But when the signals are transmitted from a distant audio-video player device through conductive wires to a display device, signals may often be attenuated, and foreign signals may be mixed with the signals received by the display device, or the transmission of signals may be interrupted, resulting in failure of the display device to receive steady signals transmitted from the audio-video player device, which may further influence the quality of display in the display device. Therefore, the conventional transmission of signals in connection with a digital device could not satisfy the needs of actual application.

### SUMMARY OF THE INVENTION

The primary objective of the present invention is to use a signal processing unit, in coordination with the input and output units of an HDMI connector, a DVI connector or a transmission line, so that the signals transmitted from an audio-video player device are received, resumed and amplified by the signal processing unit, to achieve the purpose of the audio-video player device steadily transmitting the signals to a display device.

To achieve the above purpose, the present invention relates to a signal processing device, comprising a signal processing unit that processes and converts signals; at least one input unit such as HDMI connector, DVI connector or transmission line, all input units being connected with the signal processing unit, for connection with the audio-video player device, serving as input for the signals of the audio-video player device; the output unit being connected with the signal processing unit, for connection with the display device, to transmit signals to the display device; and an operation control unit connected with the signal processing unit, for selection of signal input from different input units.

### BRIEF DESCRIPTION OF THE DRAWINGS

FIG. 1 is a perspective view of the present invention.

FIG. 2 is a block diagram of the basic structure of the present invention.

FIG. 3 is a block diagram of the present invention in its application.

### DETAILED DESCRIPTION OF THE PREFERRED EMBODIMENT

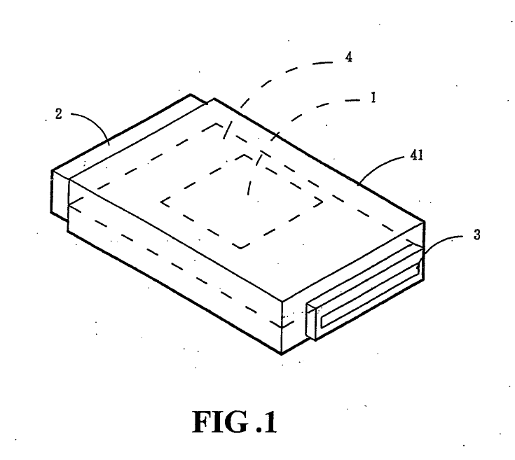

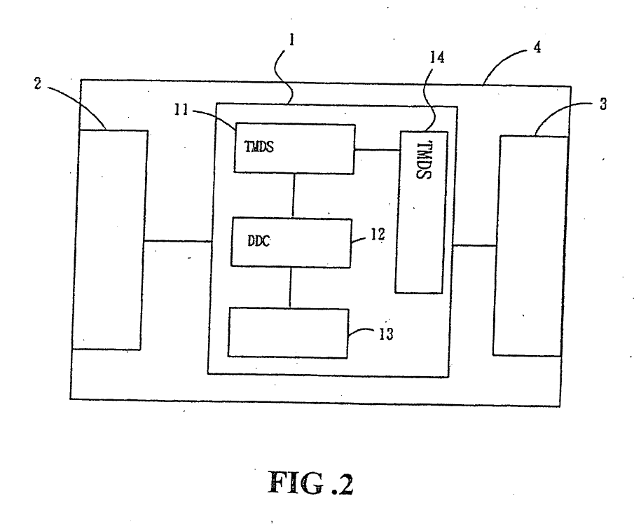

Please refer to FIGS. 1 and 2, which are respectively a perspective view and a block diagram of the basic structure of the present invention. As shown, the present invention of a signal processing device comprises a signal processing unit 1, an input unit 2 and an output unit 3. The signal processing unit 1, the input unit 2 and the output unit 3 are installed on a circuit board 4 and enveloped by a casing 41, whereby the signal output received by the signal processing unit 1 from an audio-video player device 5 is resumed and amplified, to achieve the purpose of effectively and stably transmitting the signals from the audio-video player device 5 to a display device 6.

The signal processing unit 1 serves to convert, process, amplify and resume the signals from the signal processing unit 1. The signal processing unit 1 comprises at least a TMDS signal processor 11, a DDC signal processor 12 and a power signal processor 13. The TMDS signal processor 11 is connected with a TMDS signal driver 14.

The input unit 2 can be an HDMI connector, a DVI connector or a transmission line. The input unit 2 is connected with the signal processing unit 1, for connection with the audio-video player device 5, serving as input device for receiving signals from the audio-video player device 5.

The output unit 3 can be an HDMI connector, DVI connector or a transmission line. The output unit 3 is connected with the signal processing unit 1, to connect with the display device 6, to display the signal output on the display device 6, thereby comprising an innovative signal processing device.

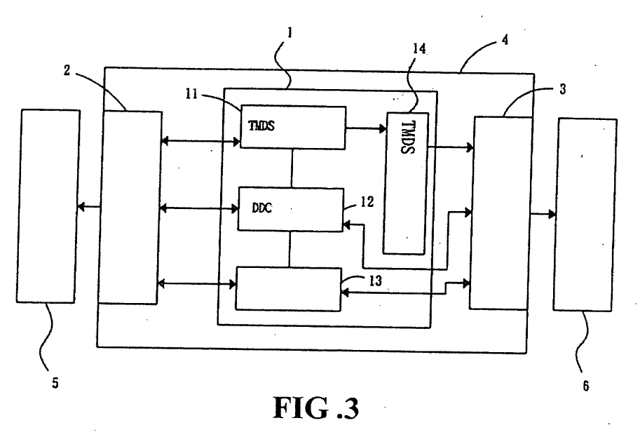

Please refer to FIG. 3 showing a block diagram of the present invention in application. As shown, the present invention is assembled by inserting the required audio-video player device 5 in the input unit 2 of the HDMI connector (the audio-video player device 5 is optionally a DVD player, DVD recorder, personal computer, notebook, etc.), which is connected to the display device 6 for connection with the output unit 3 of the HDMI connector, or DVI connector (such as TV, LCD monitor, projector, etc.) to complete the assembly of the present invention. When the audio-video player device 5 transmits signals to the display device 6, the audio-video player device 5 transmits signals to the signal processing unit 1 by way of the input unit 2, so that the signal processing unit 1, using the TMDS signal processor 11, the DDC signal processor 12, the power signal processor 13 and the TMDS signal driver 14, convert, process, amplify and resume the signals that are transmitted and attenuated from a remote source of the audio-video player device 5, and transmit the amplified signals through the output unit 3 to the display device 6. Thereby, by means of the signal processing unit 1 and the input unit 2 and the output unit 3 of the HDMI connector, the DVI connector or transmission line, the signals transmitted from the audio-video player device 5 are received, resumed and amplified by the signal processing unit are steadily transmitted by the audio-video player device 5 to the display device 6.

Summing up, the present invention of the signal processing device is capable of achieving the purpose of steadily transmitting the signals from the audio-video player device to the display device, with the signal processing unit, in cooperation with the input and output units of the HDMI connector, DVI connector or transmission line of the signal processing unit, to resume and amplify the signals received at the signal processing unit from the audio-video player device, thereby enabling the present invention to have an inventive step and applicability. Therefore, this application is duly filed for a patent right.

It is to be understood that the preferred embodiment and design drawings described above are for reference purposes, and shall not be based to restrict the scope of claim of the present invention, and that all equivalent modification or variation made without departing from the above description shall be included in the following claim.

What the invention claimed is:

1. A signal processing device, comprising:
a signal processing unit, for conversion, processing, amplifying and resumption of signals;
an input unit, in the form of an HDMI connector, a DVI connector or a transmission line, the input unit being connected with the signal processing unit, for connection with the audio-video player device, for the purpose of receiving input from the audio-video player device; and
an output unit, in the form of an HDMI connector, a DVI connector, or a transmission line, the output unit being connected with the signal processing unit, for connection with the display device, for the purpose of displaying signals on the display device.

2. The signal processing device of claim 1, wherein, the signal processing unit comprises at least a TMDS signal processor, a DDC signal processor and a power signal processor.

3. The signal processing device of claim 1, wherein, the TMDS signal processor is connected with a TMDS signal driver.

4. The signal processing device of claim 1, wherein, the signal processing unit, the input unit and the output unit are installed on a circuit board, and enveloped by a casing.
